(19) United States
(12) Patent Application Publication
(10) Pub. No.: US 2015/0202831 A1
(43) Pub. Date: Jul. 23, 2015

(54) Packaging Machine for Food Product

(71) Applicant: Oliver Packaging and Equipment Company, Walker, MI (US)

(72) Inventor: John Curtis Kortman, Grandville, MI (US)

(21) Appl. No.: 14/601,459

(22) Filed: Jan. 21, 2015

Related U.S. Application Data
(60) Provisional application No. 61/930,677, filed on Jan. 23, 2014.

(51) Int. Cl. B31B 1/64; B65B 5/02; B65B 61/06; B65B 41/02; B65B 5/04; B65B 51/16

(52) U.S. Cl. CPC B31B 1/64; B65B 5/04; B65B 51/16; B65B 61/06; B65B 41/02; B65B 5/024

(57) ABSTRACT

A packaging machine for a food product includes a folding arrangement that reconfigures a first sheet of packaging material from a planar configuration to a non-planar configuration, a supply arrangement supplying a second sheet of packaging material in a planar configuration, a first heat sealing arrangement that heat seals side edges of the first sheet to side edges of the second sheet, a cutting arrangement that cuts the first and second sheets into preselected lengths, thereby providing the sheets with first and second ends, and a second heat sealing arrangement that heats corresponding ends of the sheets with one another, such that the second sheet of material is in the substantially planar configuration when heat sealed to the first sheet of packaging material by the second heat sealing arrangement.

### BACKGROUND OF THE INVENTION

The present invention relates to a packaging machine for a food product, and in particular to a packaging machine utilizing two substantially planar sheets of packaging material to form a food package, wherein one of the sheets of packaging material is reconfigured into a non-planar configuration while the second sheet of packaging material remains in the substantially planar configuration when heat sealed to the first sheet of packaging material.

### SUMMARY OF THE INVENTION

One aspect of the present invention is to provide a packaging machine for a food product that comprises a folding arrangement that includes at least two abutment surfaces adapted to abut a first sheet of packaging material and reconfigure the first sheet of packaging material from a substantially planar configuration to a non-planar configuration as the first sheet of packaging material is drawn over the folding arrangement, wherein the first sheet of packaging material includes a pair of side edges, and a supply arrangement adapted to supply a second sheet of packaging material in a substantially planar configuration, wherein the second sheet of packaging material includes a pair of side edges. The packaging machine also includes a first heat sealing arrangement adapted to heat seal the pair of side edges of the first sheet of packaging material to the pair of side edges of the second sheet of packaging material, and a cutting arrangement adapted to cut the first sheet of packaging material and the second sheet of packaging material into preselected lengths, thereby providing the first sheet of the packaging material with first and second ends and the second sheet of packaging material with first and second ends. The packaging machine further includes a second heat sealing arrangement adapted to heat seal the first end of the first sheet of the packaging material with the first end of the second sheet of the packaging material and the second end of the first sheet of the packaging material to the second end of the second sheet of the packaging material, such that the second sheet of the packaging material is in the substantially planar configuration when heat sealed to the first sheet of packaging material by the second heat sealing arrangement.

Another aspect of the present invention is to provide a packaging machine for a food product that includes a food arrangement that includes a plurality of abutment surfaces adapted to abut a first sheet of packaging material and reconfigure the first sheet of packaging material from a substantially planar configuration to a trough-like configuration having a pair of longitudinally-extending flanges as the first sheet of packaging material is drawn over the folding arrangement, and a supply arrangement adapted to supply a second sheet of packaging material in a substantially planar configuration, wherein the second sheet of packaging material includes a pair of side flanges. The packaging machine also includes a first heat sealing arrangement adapted to heat seal the pair of flanges of the first sheet of packaging material to the pair of side edges of the second sheet of packaging material, a cutting arrangement adapted to cut the first sheet of packaging material and the second sheet of packaging material into preselected lengths, thereby providing the first sheet of packaging material with first and second ends and the second sheet of packaging material with first and second ends, and a second heat sealing arrangement adapted to heat seal the first end of the first sheet of the packaging material with the first end of the second sheet of packaging material and the second end of the first sheet of packaging material with the second end of the second sheet of the packaging material, such that the second sheet of packaging material remains in the substantially planar configuration when heat sealed to the first packaging material by the second heat sealing arrangement. The packaging machine further includes an actuator arm operably coupled with the cutter arrangement and with the second heat sealing arrangement, the actuator element adapted to move the cutting arrangement between first and second positions, wherein the cutter arrangement is spaced from the first and second sheets of packaging material when in the first position, and wherein the cutter arrangement engages the first and second sheets of the packaging material when in the second position, and wherein the actuator arm is adapted to move the second heat sealing arrangement between first and second positions, wherein the second heat sealing arrangement is spaced from the first and second sheets of packaging material when in the first position, and wherein the second heat sealing arrangement engages the at least one of the first and second sheets of the packaging material when in the second position.

Yet another aspect of the present invention is to provide a method for packaging a food product that includes providing a first sheet of packaging material in a substantially planar configuration, reconfiguring the first sheet of the packaging material from the substantially planar configuration to a non-planar configuration, placing a food product within the non-planar configuration of the first sheet of packaging material, providing a second sheet of packaging material in a substantially planar configuration, and heat sealing a pair of edges of the first sheet of packaging material to a pair of side edges of the second sheet of packaging material. The method also includes cutting the first and second sheets of packaging material to define a first end of the first sheet of packaging material and a first end of the second sheet of packaging material subsequent to heat sealing the side edges of the first sheet of packaging material to the side edges of the second sheet of packaging material. The method further includes heat sealing the first end of the first sheet of packaging material to the first end of the second sheet of packaging material, cutting the first and second sheets of packaging material to a preselected length to define a second end of the first sheet of packaging material and a second end of the second sheet of packaging material, and heat sealing the second end of the first sheet of the packaging material to the second end of the second sheet of the packaging material when the first sheet of the packaging material is in the non-planar configuration and the second sheet of the packaging material is in the substantially planar configuration.

The principle objects of the present invention are to provide a more compact design that can be operated by relatively unskilled personnel, is efficient in use, efficient in loading, capable of a long operating life, and particularly well adapted for the proposed use. In addition, the present inventive packaging machine is efficient in packaging, and allows for an easy and more simplified change of the packaging materials used therein.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a front perspective view of a packaging machine embodying the present invention;

FIG. 2 is a rear perspective view of the packaging machine;

FIG. 3 is an enlarged perspective view of the area III, FIG. 1;

FIG. 4 is a perspective view of interior components of the packaging machine;

FIG. 5A is a cross-sectional view of a food product package;

FIG. 5B is a top plan view of the food product package;

FIG. 6 is a perspective view of interior components of the packaging machine;

FIG. 7 is a top plan view of interior components of the packaging machine;

FIG. 8 is a rear perspective view of the packaging machine showing heat sealing and cutting arrangements thereof; and

FIG. 9 is an end perspective view of a heat sealer of the packaging machine.

### DETAILED DESCRIPTION OF PREFERRED EMBODIMENT

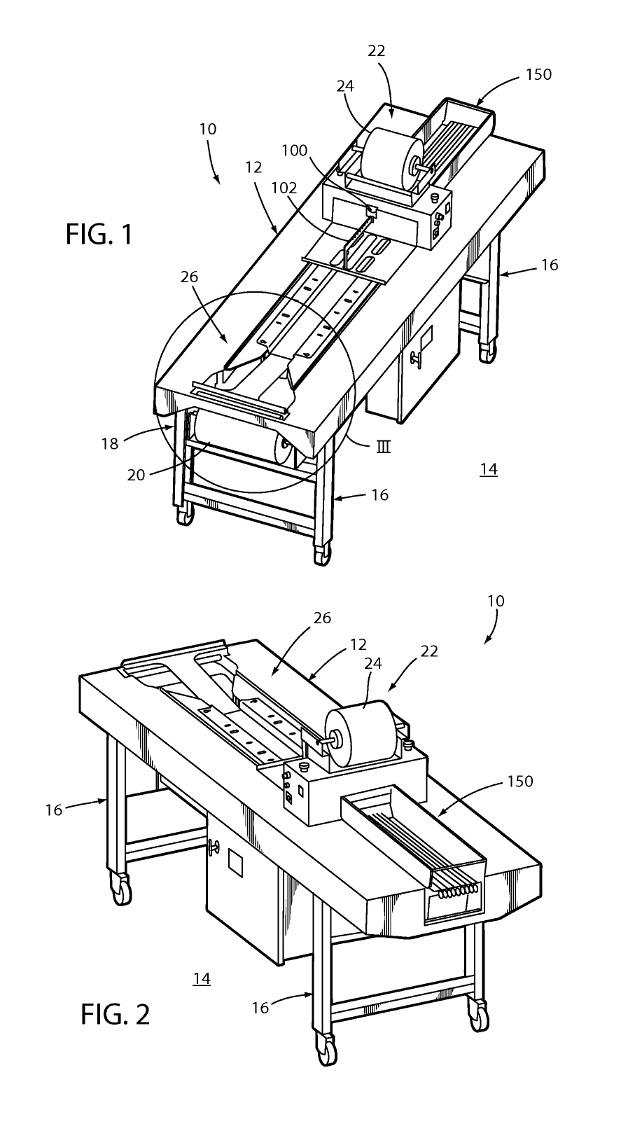

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

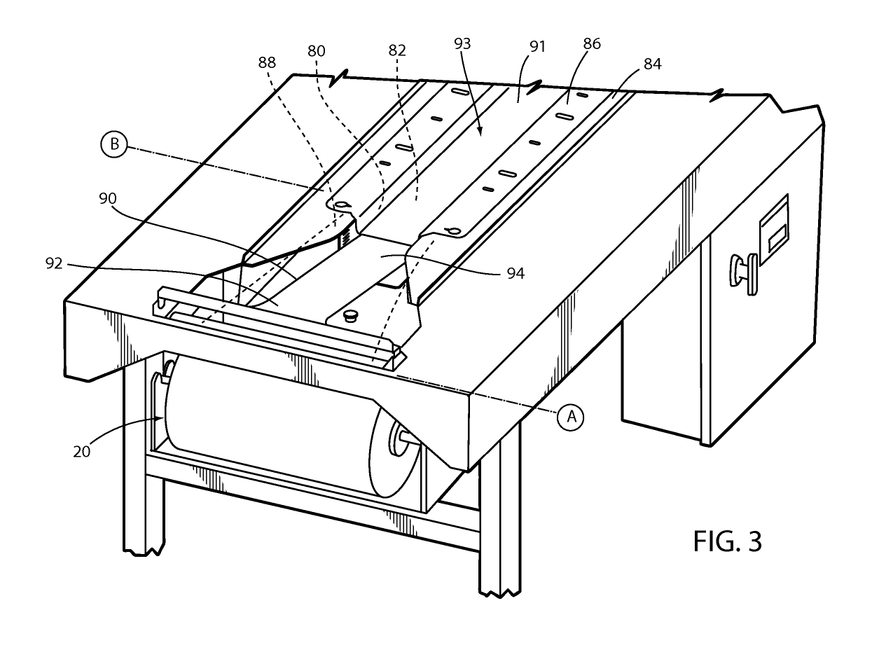

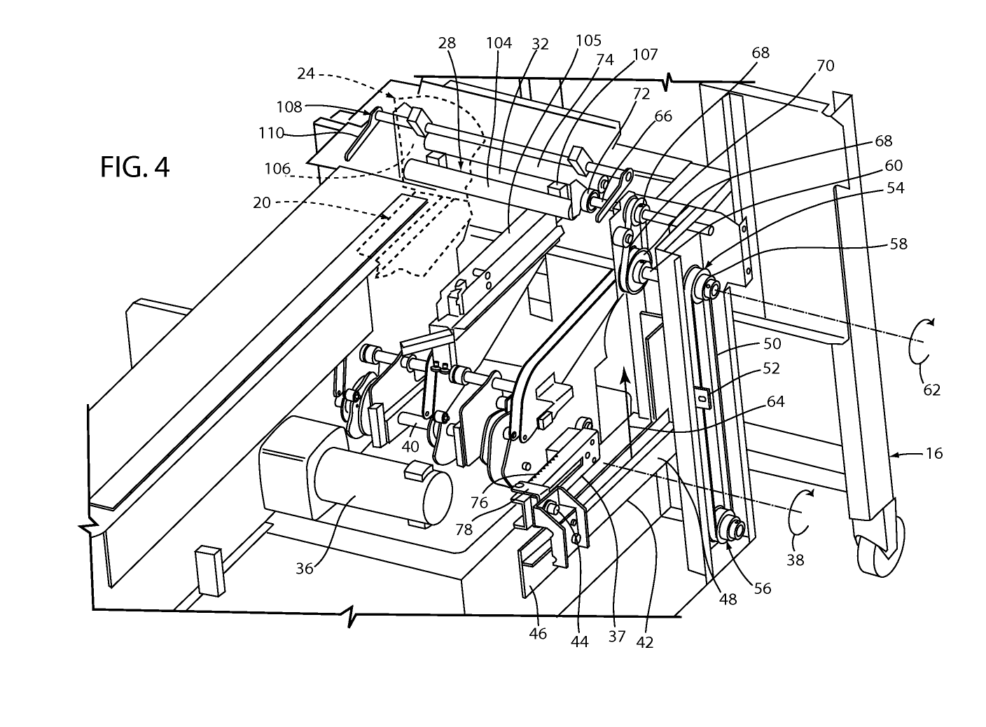

The reference numeral 10 (FIGS. 1 and 2) generally designates a packaging machine for a food product embodying the present invention. In the illustrated example, the packaging machine 10 includes a main structure 12 supported above a ground surface 14 by a pair of leg assemblies 16. The main structure 12 includes a first supply arrangement 18 supporting and supplying a first sheet of packaging material 20, and a second supply arrangement 22 supporting and supplying a second sheet of packaging material 24. The packaging machine 10 also includes a folding arrangement 26 that reconfigures the first sheet of packaging material 20 from a substantially planar configuration to a non-planar configuration, as described below. The packaging machine 10 further includes a first heat sealer 28 that seals together edges of the first and second sheets of packaging material 20, 24, a second heat sealer 30 (FIG. 4) that seals the ends of the produced packages together, and a cutting arrangement 32 that cuts the first and second sheets of packaging material 20, 24 into package lengths, each as described below. In the illustrated example, the first and second sheets of packaging material 20, 24 each comprise at least one of a heat sealable plastic film, a polyester film, a polyolefin film, and the like, and/or other films used with or without heat activated adhesives.

The first sheet of packaging material 20 (FIG. 3) is provided in the form of a rolled sheet having a substantially planar cross-section at a position A as the sheet material is withdrawn from the associated roll by a roller assembly 34. More particularly, a drive motor 36 (FIG. 4) drives a main crank member 37 in the direction 38 via a main drive shaft 40. The crank member 37 is operably coupled to a horizontal bar 42 via a bearing assembly 44 located near a first end 46 of the horizontal bar 42. A second end 48 of the horizontal bar 42 is clamped to a drive belt 50 via a clamping assembly 52. The drive belt 50 extends between a first pulley assembly 54 and a second pulley assembly 56, wherein the first pulley assembly 54 includes a one-way clutch 58, such that the first pulley assembly 54 drives a roller drive shaft 60 in a direction 62 only during an upward stroke of the horizontal bar 42 in a direction 64. The roller drive shaft 60 is coupled to a pinch roller shaft 66 via a pair of timing pulleys 68 and a timing belt 70 extending therebetween, with a similar assembly (not shown) located on the opposite side of the packaging machine 10. Each pinch roller shaft 66 drives a corresponding lower pinch roller 72 of the roller assembly 34. The lower pinch rollers 72 cooperate with an upper pinch roller 74 to draw the first and second sheets of packaging material 20, 24 as described below.

The second sheet of packaging material 24 is provided in the form of a rolled sheet supported above the second heat sealer 30 and the cutting arrangement 32 such that the second sheet of packaging material 24 passes between the lower pinch rollers 72 and the upper pinch roller 74. In operation, the lower pinch rollers 72 are driven in the manner as described above, thereby drawing the first and second sheets of the packaging material 20, 24 through the packaging machine 10 by sandwiching or pinching the first and second sheets 20, 24 between the lower pinch rollers 72 and the upper pinch roller 74.

As best illustrated in FIG. 4, the crank 24 is provided with a plurality of graduations or notches 76 along the length thereof. A coupler assembly 78 selectively engages the graduations 76 and operably couples the bearing assembly 44 to the crank 37 along the length of the crank 37. Adjustment of the position of the bearing 44 along the length of the crank 37 changes the effective stroke length of the horizontal bar 42 in the direction 64 thereby decreasing the amount of rotation of the roller drive shaft 60 in the direction 62 as the bearing assembly 44 is positioned relatively closer to the main drive shaft 40. The overall effect of the positioning of the bearing assembly 44 with respect to the main drive shaft 40 changes the length of the overall package as created from the first and second sheets of packaging material 20, 24, as described below.

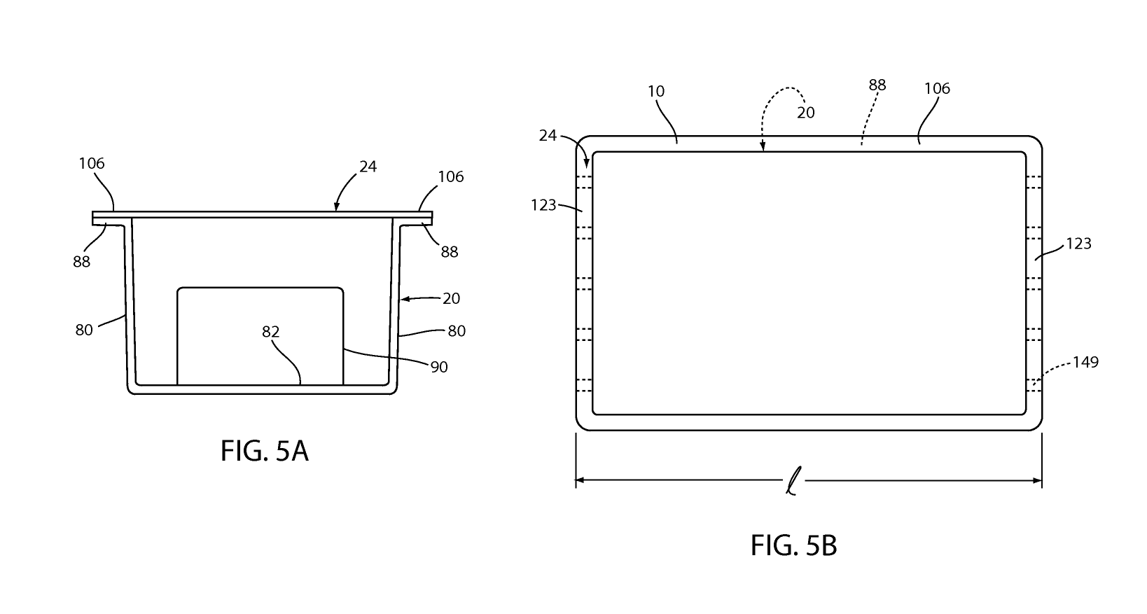

The first sheet of packaging material 20 is deformed or reconfigured from the substantially planar configuration at the position A to a non-planar, trough-like configuration at position B, and as illustrated in FIG. 5A. The trough-like shape having a pair of sidewalls 80, a bottom wall 82, and a pair of flanges 88 extending outwardly form the sidewalls 80. Specifically, the folding arrangement 26 includes a pair of bottom plates 84 that cooperate with a corresponding pair of top plates 86 to trap and create the flanges 88 within the first sheet of packaging material 20. A tray member 91 cooperates with the top plates 86 to form a rectangularly-shaped tunnel 93. A guide member 90 is pivotably coupled to the main structure 12 at a first end 92 thereof, while a second end 94 rests upon the first sheet of packaging material 20 forcing the first sheet of packaging material 20 downward into the tunnel 93 thereby forming the sidewalls 80 and the bottom wall 82.

In operation, the operator places a food product 90 into the interior of the trough formed in the first sheet of packaging material 20. An optic sensor 100 is supported vertically above the trough formed within the first sheet 20 by a supporting arrangement 102 so as to ensure proper placement of the food product.

The first heat sealing arrangement 20 (FIG. 4) includes a roller 104 and a pair of heating blocks 107 that heat seals the edges 106 of the second sheet of packaging material 24 to the corresponding side edges or flanges 88 of the first sheet of packaging material 20 (FIGS. 5A and 5B). In the illustrated example, the first sheet of packaging material 20 is in the trough-like shape and the second sheet of the packaging material 24 is in a planar configuration when the side edges 106, 88 are heat sealed to one another.

In assembly, loading or feeding of the first and second sheets of packaging material 20, 24 are aided by a lift assembly 108. As illustrated, the lift assembly 108 includes a lift handle 110 accessible to an operator, and which allows the operator to lift the roller 104 and the heating blocks 107 and the upper pinch roller 74, thereby spacing the heated roller 104 from associated heat sealing bolts 105 and the top pinch roller 74 from the bottom pinch roller 72.

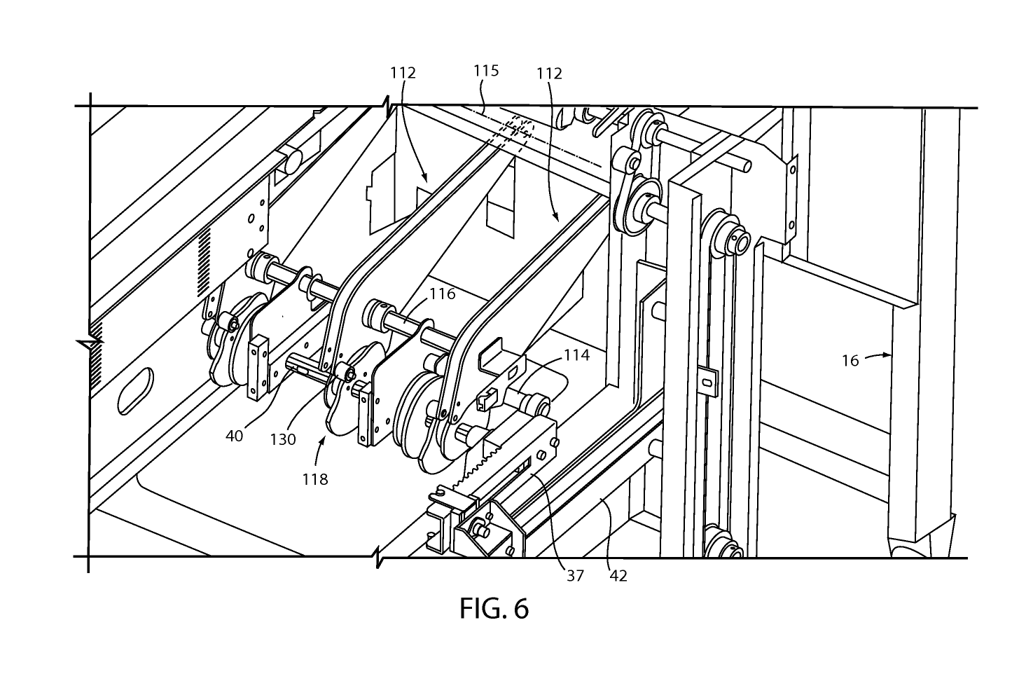

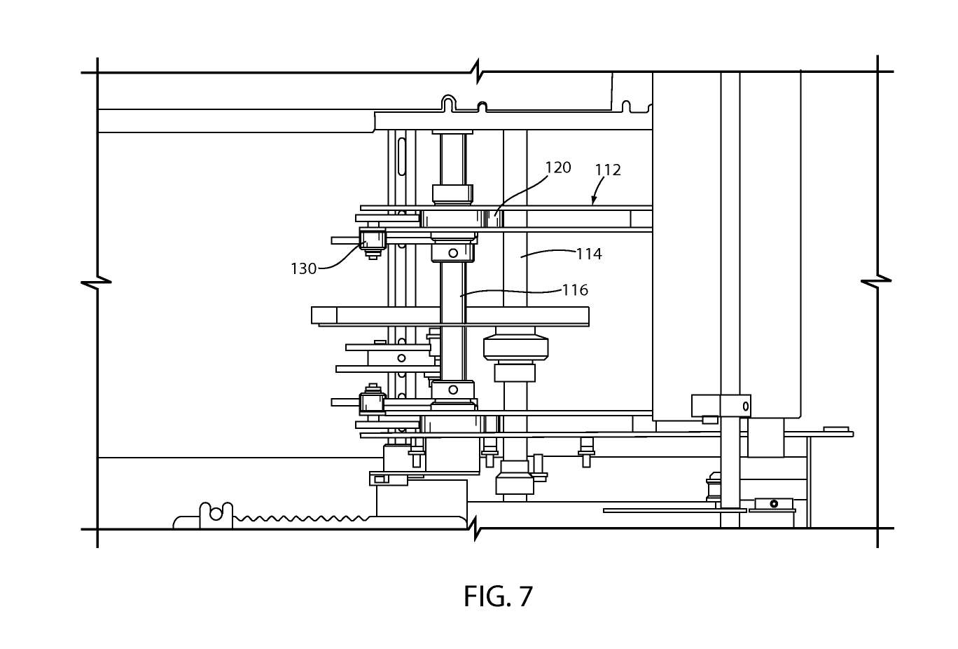

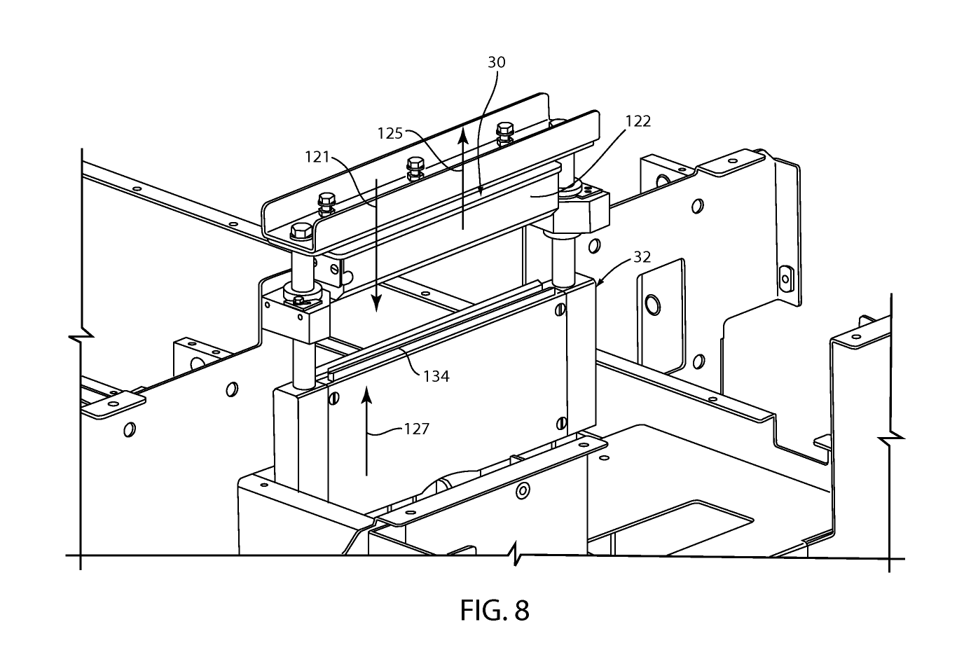

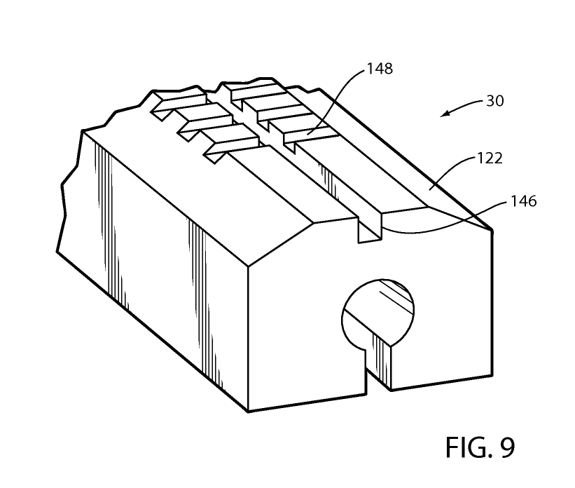

The second heat sealer 30 and the cutting arrangement 32 are actuated cam arms 112 (FIG. 6). Each cam arm 112 is pivotable about a main pivot shaft 114 secured to the main structure 12, pivotably coupled to the cutting arrangement 32 along a pivot axis 115, and pivotably coupled to one another via a coupling pivot shaft 116. Each cam arm 112 is driven by a corresponding cam assembly 118. Each cam assembly 118 includes a first cam 120 (FIG. 7) that cooperates with the cam arm 112 to extend or move the second heat sealing arrangement 30 (FIG. 8) in a downward direction 121 from a first position, wherein a platen 122 (FIG. 9) of the second sealing arrangement 30 is spaced from the first and second sheets of packaging material 20, 24, to a second position, wherein the platen 122 abuts the second sheet of packaging material 24, thereby sealing an end 123 of the second sheet 24 to an end of the first sheet 20. The cam assembly 118 also includes a second cam 130 that cooperates with the cam arm 112 to retract or move the platen 122 in a direction 125 from the second position to the first position. The cam assembly 118 further includes a third cam 132 that cooperates with the cam arm 112 to move the cutting arrangement 32 in a direction 127 between a first position, wherein a serrated cutting bar 134 is spaced from the platen 122, and a second position, wherein the bar 134 engages a longitudinally-extending groove 146 of the platen 122, thereby severing the first and second sheets 20, 24 to preselected package lengths e. The platen 122 also includes a plurality of laterally-extending grooves 148 spaced longitudinally along the length of the platen 122, and that allow the platen 122 to selectively seal the ends 123 and provide ventilation holes 149 (FIG. 5B) in the resulting food package. The amount of venting may be controlled by adjusting the size of the grooves 148 and/or the spacing therebetween. The packaged food product is then dispensed into a package for tray and conveyor assembly 150 where it is collected and removed by the operator.

The above description is considered that of the preferred embodiment only. Modifications of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

The invention claimed is:

1. A packaging machine for a food product, comprising:
a folding arrangement that includes at least two abutment surfaces adapted to abut a first sheet of packaging material and reconfigure the first sheet of packaging material from a substantially planar configuration to a non-planar configuration as the first sheet of packaging material is drawn over the folding arrangement, wherein the first sheet of packaging material includes a pair of side edges;
a supply arrangement adapted to supply a second sheet of packaging material in a substantially planar configuration, wherein the second sheet of packaging material includes a pair side edges;
a first heat sealing arrangement adapted to heat seal the pair of side edges of the first sheet of packaging material to the pair of side edges of the second sheet of packaging material;
a cutting arrangement adapted to cut the first sheet of packaging material and the second sheet of packaging material into preselected lengths, thereby providing the first sheet of packaging material with first and second ends and the second sheet of packaging material with first and second ends; and
a second heat sealing arrangement adapted to heat seal the first end of the first sheet of the packaging material with the first end of the second sheet of the packaging material and the second end of the first sheet of the packaging material with the second end of the second sheet of the packaging material, such that the second sheet of material is in the substantially planar configuration when heat sealed to the first sheet of packaging material by the second heat sealing arrangement.

2. The packaging machine of claim 1, wherein the at least two abutment surfaces includes a plurality of abutment surfaces that cooperate to form a rectangular shape, and wherein the non-planar configuration of the first sheet of packaging material is trough-like shaped.

3. The packaging machine of claim 2, wherein the at least two abut surfaces cooperate to form flanges on an outside of the trough-like shape of the first sheet of packaging material, and wherein the flanges include the pair of side edges of the first sheet of packaging material.

4. The packaging machine of claim 3, further comprising:
a pair of rollers positioned on opposite surfaces of the first and second sheets of packaging materials and adapted to engage and draw the first and second sheets of packaging material through the packaging machine.

5. The packaging machine of claim 4, further comprising:
an actuator arm operably coupled with the cutter arrangement and adapted to move the cutting arrangement between first and second positions, wherein the cutter arrangement is spaced from the first and second sheets of packaging material when in the first position, and wherein the cutter arrangement engages the first and second sheets of packaging material when in the second position.

6. The packaging machine of claim 5, wherein the actuator arm is operably coupled with the second heat sealing arrangement and is adapted to move the second heat sealing arrangement between first and second positions, wherein the second heat sealing arrangement is spaced from the first and second sheets of packaging material when in the first position, and wherein the second heat sealing arrangement engages at least one of the first and second sheets of packaging material when in the second position.

7. The packing machine of claim 6, further comprising:
a drive motor that moves the cutter arrangement between the first and second positions, moves the second heat sealing arrangement between the first and second positions, and drives the pair of rollers to draw the first and second sheets of packaging material through the packaging machine.

8. The packaging machine of claim 1, wherein the at least two abut surfaces cooperate to form flanges on an outside of the non-planar configuration of the first sheet of packaging material, and wherein the flanges include the pair of side edges of the first sheet of packaging material.

9. The packaging machine of claim 1, further comprising:
a pair of rollers positioned on opposite surfaces of the first and second sheets of packaging materials and adapted to engage and draw the first and second sheets of packaging material through the packaging machine.

10. The packaging machine of claim 1, further comprising:
an actuator arm operably coupled with the cutter arrangement and adapted to move the cutting arrangement between first and second positions, wherein the cutter arrangement is spaced from the first and second sheets of packaging material when in the first position, and wherein the cutter arrangement engages the first and second sheets of packaging material when in the second position.

11. The packaging machine of claim 1, wherein an actuator arm is operably coupled with the second heat sealing arrangement and is adapted to move the second heat sealing arrangement between first and second positions, wherein the second heat sealing arrangement is spaced from the first and second sheets of packaging material when in the first position, and wherein the second heat sealing arrangement engages the first and second sheets of packaging material when in the second position.

12. The packaging machine of claim 1, further comprising:
a pair of rollers positioned on opposite surfaces of the first and second sheets of packaging materials and adapted to engage and draw the first and second sheets of packaging material through the packaging machine;
an actuator arm operably coupled with the cutter arrangement and adapted to move the cutting arrangement between first and second positions, wherein the cutter arrangement is spaced from the first and second sheets of packaging material when in the first position, and wherein the cutter arrangement engages the first and second sheets of packaging material when in the second position, wherein the actuator arm is operably coupled with the second heat sealing arrangement and is adapted to move the second heat sealing arrangement between first and second positions, wherein the second heat sealing arrangement is spaced from the first and second sheets of packaging material when in the first position, and wherein the second heat sealing arrangement engages at least one of the first and second sheets of packaging material when in the second position; and
a drive motor that moves the cutter arrangement between the first and second positions, moves the second heat sealing arrangement between the first and second positions, and drives the pair of rollers to draw the first and second sheets of packaging material through the packaging machine.

13. The packaging machine of claim 1, wherein the second heating arrangement is adapted to intermittently seal the ends of the first and second sheets to one another.

14. A packaging machine for a food product, comprising:
a folding arrangement that includes a plurality of abutment surfaces adapted to abut a first sheet of packaging material and reconfigure the first sheet of packaging material from a substantially planar configuration to a trough-like configuration having a pair of longitudinally-extending flanges as the first sheet of packaging material is drawn over the folding arrangement;
a supply arrangement adapted to supply a second sheet of packaging material in a substantially planar configuration, wherein the second sheet of packaging material includes a pair side edges;
a first heat sealing arrangement adapted to heat seal the pair of flanges of the first sheet of packaging material to the pair of side edges of the second sheet of packaging material;
a cutting arrangement adapted to cut the first sheet of packaging material and the second sheet of packaging material into preselected lengths, thereby providing the first sheet of packaging material with first and second ends and the second sheet of packaging material with first and second ends;
a second heat sealing arrangement adapted to heat seal the first end of the first sheet of the packaging material with the first end of the second sheet of the packaging material and the second end of the first sheet of the packaging material with the second end of the second sheet of the packaging material, such that the second sheet of material remains in the substantially planar configuration when heat sealed to the first packaging material by the second heat sealing arrangement; and
an actuator arm operably coupled with the cutter arrangement and with the second heat sealing arrangement, the actuator element adapted to move the cutting arrangement between first and second positions, wherein the cutter arrangement is spaced from the first and second sheets of packaging material when in the first position, and wherein the cutter arrangement engages the first and second sheets of packaging material when in the second position, and wherein the actuator arm is adapted to move the second heat sealing arrangement between first and second positions, wherein the second heat sealing arrangement is spaced from the first and second sheets of packaging material when in the first position, and wherein the second heat sealing arrangement engages at least one of the first and second sheets of packaging material when in the second position.

15. The packaging machine of claim 14, further comprising:
a pair of rollers positioned on opposite surfaces of the first and second sheets of packaging materials and adapted to engage and drawing the first and second sheets of packaging material through the packaging machine.

16. The packing machine of claim 15, further comprising:
a drive motor that moves the cutter arrangement between the first and second positions, moves the second heat sealing arrangement between the first and second positions, and drives the pair of rollers to draw the first and second sheets of packaging material through the packaging machine.

17. The packaging machine of claim 14, wherein the second heating arrangement is adapted to intermittently seal the ends of the first and second sheets to one another.

18. A method of packaging a food product, comprising:
providing a first sheet of packaging material in a substantially planar configuration;
reconfiguring the first sheet of the packaging material from the substantially planar configuration to a non-planar configuration;
placing a food product with the non-planar configuration of the first sheet of packaging material;
providing a second sheet of packaging material in a substantially planar configuration;
heat sealing a pair of side edges of the first sheet of packaging material to a pair of side edges of the second sheet of packaging material;
cutting the first and second sheets of packaging material to define a first end of the first sheet and a first end of the second sheet subsequent to heat sealing the side edges of the first sheet to the side edges of the second sheet;
heat sealing the first end of the first sheet of packaging material to the first end of the second sheet of packaging material;
cutting the first and second sheets of packaging material to a preselected length and to define a second end of the first sheet and a second end of the second sheet; and
heat sealing the second end of the first sheet of packaging material to the second end of the second sheet of packaging material when the first sheet of packaging material is in the non-planar configuration and the second sheet of packaging material is in the substantially planar configuration.

19. The method of claim 16, wherein the non-planar configuration is trough-shaped.

20. The method of claim 17, wherein the non-planar configuration includes a pair of longitudinally-extending flanges that include the side edges of the first sheet of packaging material.

21. The method of claim 16, further including:
advancing the first and second sheets of packaging material by a pair of rollers between the step of heat sealing the first end of the first sheet to the first end of the second sheet and the step of cutting the first and second sheets of material to preselected lengths.
